(19) United States
(12) Patent Application Publication
(10) Pub. No.: US 2002/0125313 A1
(43) Pub. Date: Sep. 12, 2002

(54) Label scanner for food products and method of updating a food product database

(76) Inventor: Martin D. Broff, Braintree, MA (US)

Correspondence Address: Gregory J. Cohan, BANNER & WITCOFF, LTD, 28th Floor, 28 State Street, Boston, MA, 02109, US

(21) Appl. No.: 09/803,439

(22) Filed: Mar. 9, 2001

(51) Int. Cl. G06K 15/00

(52) U.S. Cl. 235/383

(57) ABSTRACT

A method of updating a database listing ingredients of food products sold, where the database resides in a portable device used to scan food product labels to detect the presence of particular ingredients in food products, includes the steps of obtaining information regarding the ingredients of food products sold to consumers, updating a database that lists ingredients of food products, and transmitting the updated database to a desired number of portable devices used to scan product labels. A portable device for scanning a food product label includes a keypad, a display, a barcode scanner, a database listing ingredients of food products, a processor to compare the target food product ingredient to the database of ingredients, and an indicator to indicate whether or not the target food product ingredient is present, and when the database does not include the scanned product.

### INTRODUCTION

The present invention is directed to a label scanner for food products, and, more particularly, to a label scanner for detecting the presence of particular ingredients in food products and a method for updating a database of ingredients in food products.

### BACKGROUND

Allergy to food products is becoming more and more common. A severe allergic reaction, such as anaphylaxis, is potentially life threatening. Common foods, including cow's milk and dairy products, eggs, nuts, and particularly peanuts, can all cause dangerous reactions if a sensitive individual ingests them. Schools have even gone to great lengths to provide peanut-free zones in efforts to avoid potential liability situations.

Allergy to food can cause a great deal of concern and consternation in individuals, and in parents of children, when they attempt to purchase foods while avoiding the offending allergen. Physicians specializing in allergy recommend to these individuals that the only method of safely selecting appropriate foods is to carefully read labeling and nutritional information before purchasing products. Individuals often have difficulty determining which of the foods they wish to purchase do, or do not, contain the offending allergens. Reading labels on food product boxes, jars and cans is a very tedious, time-consuming, and confusing process. Many products may contain ingredients that one may not associate with that food, but that may be allergenic to that individual.

Products may be known by various names, e.g., cow's milk products include milk proteins, milk solids, casein and whey. Peanut products include not only peanut protein, but also peanut oils. Hazelnuts are also known as Filberts. Likewise, individuals with other dietary restrictions (e.g., sodium, fat, gluten, etc.) also must carefully read labeling and nutritional information. This can prove to be extremely time consuming and tedious. Additionally, new products continue to be introduced into the marketplace, and established products may be reformulated, reducing an individual's ability to learn which products are safe, and which are not.

U.S. Pat. No. 5,478,989 to Shepley discloses an apparatus for generating personalized nutritional information. An individual inputs personal data such as their age, weight, and dietary regulated conditions into the apparatus. The apparatus has an input device, e.g., barcode label reader, for inputting data identifying the food product that the individual intends to purchase. Shepley is limited in that it does not provide a quick and easy to read indicator as to the suitability of a particular food product for an individual with a particular allergy. More importantly, Shepley does not disclose a method of updating its database to incorporate new food products as they are introduced into the marketplace, or to incorporate changes to the ingredients of existing food products.

It is an object of the present invention to provide a portable hand-held device for indicating the presence of allergens in food products, and a method of updating a database in the portable device to incorporate new and changed products, which reduce or wholly overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of preferred embodiments.

### SUMMARY

The principles of the invention may be used to advantage to provide an easy way to detect the presence of a selected ingredient in food products by scanning the UPC barcode on a food label with a portable hand-held device. The device contains a database listing the ingredients of food products, indexed by UPC code. The device finds the product ingredients of the scanned product in the database and checks for the selected ingredient. The device then indicates, via an easy-to-read indicator, whether the food product contains the selected ingredient, whether it does not contain the selected ingredient, or whether the food product is not listed in the database. The database is updated to incorporate new food products that come on the market, or to incorporate changes to existing food products.

In accordance with a first aspect, a method of updating a database listing ingredients of food products sold, with the database residing in a portable device used to scan food product labels to detect the presence of particular ingredients in food products, includes the steps of obtaining information regarding the ingredients of food products sold to consumers, updating the database that lists ingredients of food products, and transmitting the updated database to a desired number of portable devices used to scan food product labels to detect the presence of particular ingredients.

In accordance with another aspect, a portable device for scanning a food product label to detect an ingredient of the food product includes a keypad to enter data regarding a target food product ingredient a user is trying to detect and a display. A barcode scanner scans a barcode of a food product. A processor compares the food ingredient the user is trying to detect to a database listing the ingredients of food products. An indicator indicates when an ingredient is present in a food product, when the ingredient is not present in the food product, and when the database does not include the scanned food product.

From the foregoing disclosure, it will be readily apparent to those skilled in the art, that is, those who are knowledgeable or experienced in this area of technology, that the present invention provides a significant advance. Preferred embodiments of the food label scanner and method of updating a database of a food label scanner of the present invention can provide a fast and easy way to detect selected ingredients in food products, and a reliable method for updating a database in the food label scanner as new products are introduced into the marketplace and existing products are changed. These and additional features and advantages of the invention disclosed here will be further understood from the following detailed disclosure of preferred embodiments.

### BRIEF DESCRIPTION OF THE DRAWINGS

Preferred embodiments are described in detail below with reference to the appended drawings.

FIG. 1 is a perspective view of a portable label-scanning device in accordance with the present invention, shown scanning a label on a food product.

FIG. 2 is a schematic representation of the components of the label-scanning device of FIG. 1.

FIG. 3 is a representation of main menu options displayed to a user on the display of the scanning device of FIG. 1 in accordance with a preferred embodiment of the present invention; and

FIG. 4 is a representation of sub-menu options displayed to a user on the display of the scanning device of FIG. 1 in accordance with a preferred embodiment of the present invention.

The figures referred to above are not drawn necessarily to scale and should be understood to present a representation of the invention, illustrative of the principles involved. Some features of the food label scanner depicted in the drawings have been enlarged or distorted relative to others to facilitate explanation and understanding. The same reference numbers are used in the drawings for similar or identical components and features shown in various alternative embodiments.

### DETAILED DESCRIPTION OF PREFERRED EMBODIMENTS

The present invention allows a user to scan a food product label in order to detect the presence of particular ingredients, e.g., allergens, and provides a method for updating a database contained in a food label scanner.

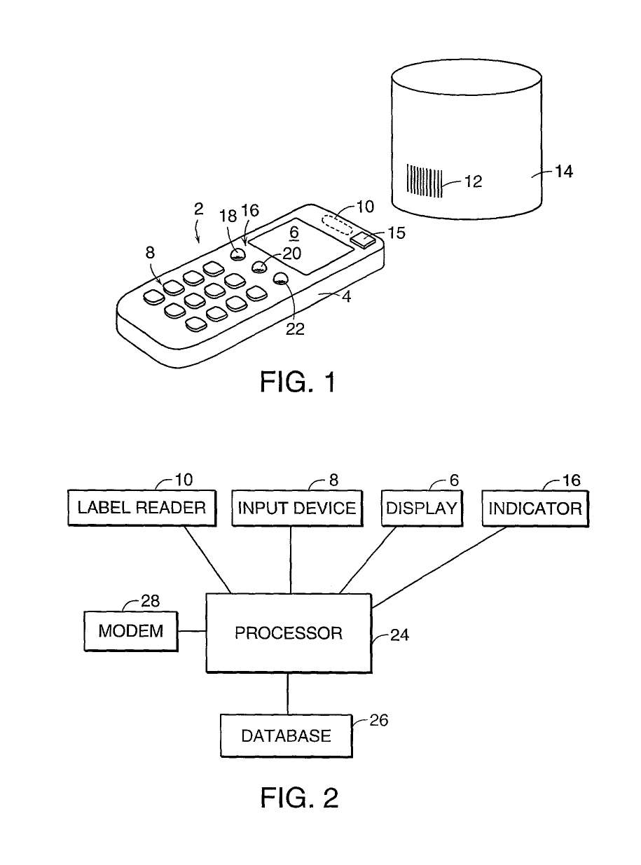

A portable label scanning device 2 in accordance with the present invention is shown in FIG. 1. Scanning device 2 includes a housing 4 having a display 6. Display 6 is preferably a screen display capable of displaying text and character information to a user, e.g., an LCD display. A data input device 8 enables a user to enter data into scanning device 2. In certain preferred embodiments, data input device 8 is a keypad. Data input device 8 could, alternatively, be a touch sensitive screen, or any other device capable of receiving input from a user. A user will enter a particular target ingredient, or ingredients, that they are checking for, e.g., allergen(s). A food label reader 10 is provided for reading information from a food product label. In a preferred embodiment, label reader 10 is a barcode scanner for scanning a barcode label, typically provided on food products. Other types of label readers are considered to be within the scope of the present invention including, for example, infrared readers. It is to be appreciated that the barcode label need not necessarily be on the food product itself. In certain stores, barcode labels are actually provided on the shelving where the food product is displayed, or on pricing display units adjacent the shelving where the food product is displayed.

In use, as seen in FIG. 1, a user inputs a target ingredient, or ingredients, into scanning device 2 via input device 8. For example, a user could enter an allergen such as “peanuts” as a target ingredient. Scanning device 2 is then pointed by the user toward a barcode label 12 on a food product 14. Label reader 10 scans the barcode label, which is unique to each food product sold in stores. In certain preferred embodiments, a button 15 is depressed by a user in order to activate label reader 10, e.g., in the embodiment where label reader 10 is a light activated barcode scanner.

A processor of scanning device 2 then reads a database containing the ingredients of food products sold in stores to determine if the target ingredient input by the user is present in the food product. It is to be appreciated that the scanning device can search for multiple ingredients, however, the bulk of the discussion herein is directed to embodiments in which a single ingredient is searched for by the scanning device. An indicator 16 on scanning device 2 indicates to a user whether or not the target ingredient, e.g., an allergen, is present. In a preferred embodiment, indicator 16 comprises three LED lights. A first LED light 18, e.g., a red light, is illuminated if the target ingredient is present in the food product. A second LED light 20, e.g., a green light, is illuminated if the target ingredient is not present in the food product. A third light 22, e.g., a yellow light, is illuminated if the food product's ingredients are not in the database. In the case where the third light is illuminated, a user must review the food product label manually, or reject the product if they cannot safely determine its ingredients.

In another preferred embodiment, indicator 16 could provide audible sound to the user to indicate whether or not the target ingredient is present in the scanned product. Different sounds could be used to indicate that the target ingredient is present, is not present, or if the product is not in the database. The audible sounds could be beeps, chirps, sirens, or any other suitable audible sounds. Such audible sounds could be used in place of, or in addition to, the lights described above. Thus, a user is provided with a portable device that allows them to quickly scan a product, and which provides a fast, efficient, and accurate indication of whether or not the target ingredient is present in the food product, or if the device has insufficient data to determine whether or not the target ingredient is present.

Scanning device 2 is shown schematically in FIG. 2. Input device 8, label reader 10, display 6, and indicator 16 are all linked to processor 24 of the scanning device. A database 26, containing a list of products and their associated ingredients, is also linked to processor 24. As noted above, as a product is scanned by label reader 10, database 26 is read to see if the target ingredient, input by a user through input device 8, is an ingredient of the product.

A problem faced by consumers looking for particular ingredients or allergens in food products is that new and revised products are continually being introduced to the marketplace. A new food product, or a change in the ingredients of an existing product, necessitates an update of database 26. Thus, a method is needed to ensure that the database is updated on a regular basis. In certain preferred embodiments, a user can sign up for a subscription to have updates of the database sent to them by a provider on a regular basis. Database 26 will be maintained by a service provider in order to incorporate new products as they are introduced to the market, or to update the database as the ingredients of existing products are modified. The provider will then distribute an updated database to each subscriber. The database can be sent to the users in a variety of manners. For example, in certain preferred embodiments, in which database 26 is contained in a read-only-memory (ROM) chip in scanning device 2, the provider will send an updated ROM chip to the user on a scheduled basis. The user will then remove the old outdated ROM chip and replace it with the new ROM chip.

In other preferred embodiments, where database 26 of scanning device 2 is not included in a removable chip, an updated database can be sent directly to scanning device 2. This can be accomplished in a variety of manners. For example, the database can be downloaded via modem 28 directly to scanning device 2, or through a user's personal computer, to which scanning device 2 could be connected. In another preferred embodiment, scanning device 2 could be a device having a wireless communication capability, e.g., a personal data assistant, that can directly communicate with a host from which the revised database can be downloaded. It is to be appreciated that any communication method of transmitting electronic data suitable for transmission of an updated database to a user's scanning device is considered within the scope of the invention.

Scanning device 2 can be used to scan for any target allergen, such as dairy, egg, peanut, nuts, wheat, fish, shellfish, etc. Additionally, scanning device 2 can scan for other target items, such as high levels of sodium, cholesterol, fat, sugar, preservatives, dyes, or any other food ingredients or categories. Thus, the device of the present invention can be used for individuals with allergies and their caregivers, as well as individuals with other health concerns that require careful monitoring of foods, such as cardiac patients, diabetics, and those interested in losing weight.

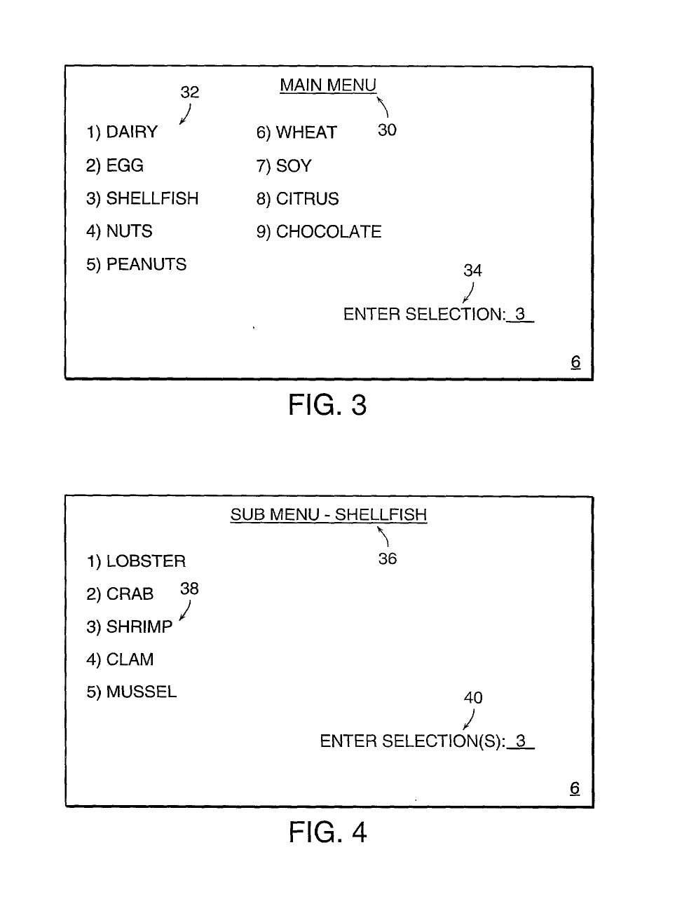

In certain preferred embodiments, scanning device 2 is configured such that display 6 provides a user with a menu structure from which they can select the target ingredient they are searching for in food products. Such a menu structure can be implemented in any known fashion. For example, as seen in FIG. 3, display 6 provides the user with a main menu 30, including a number of food categories 32 from which they may make a selection. A prompt 34 is provided for the user to enter the number of the category of concern. In the illustrated embodiment, the user has entered category 3, shellfish. Then, as seen in FIG. 4, a sub-menu 36 is displayed, showing a list 38 of particular foods within that category that the user may select. A prompt 40 is provided for the user to select an item, or items, from the displayed list. In the illustrated embodiment, the user has selected item 3: shrimp. The scanning device will then search the database when food products are scanned, and the indicator will notify the user when shrimp is found as an ingredient of a scanned food product. It is to be appreciated that multiple sub-menus may be used to provide the user with additional food product ingredient choices, and the ability to select multiple ingredient items to identify.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

1. A method of updating a database listing ingredients of food products sold, the database residing in a portable device used to scan food product labels to detect the presence of particular ingredients in food products, comprising the steps of:
obtaining information regarding the ingredients of food products sold to consumers;
updating a database that lists ingredients of food products; and
transmitting the updated database to a desired number of portable devices used to scan food product labels to detect the presence of particular ingredients.

2. The method of claim 1, wherein the step of transmitting the database to a portable device includes replacing a read-only-memory chip of the portable device with a read-only-memory chip having the updated database.

3. The method of claim 1, wherein the step of transmitting the database to a portable device includes sending the database via the Internet.

4. The method of claim 1, wherein the step of transmitting the database to a portable device includes sending the database via a modem.

5. The method of claim 1, further including the step of repeating the steps of obtaining information regarding the ingredients of food products, creating an updated database, and transmitting the updated database on a scheduled basis.

6. The method of claim 5, wherein a provider that updates the database provides updated databases to users on a subscription basis.

7. A portable device for scanning a food product label to detect an ingredient of the food product comprising, in combination:
a keypad to enter a target food product ingredient a user is trying to detect;
a display;
a barcode scanner to scan a barcode of a food product;
a database listing ingredients of food products;
a processor to compare the target food product ingredient to the database of ingredients; and
an indicator to indicate when the target food product ingredient is present in a food product, when the target food product ingredient is not present in the food product, and when the database does not include the scanned food product.

8. The portable device of claim 7, wherein the indicator comprises three lights, a first of the lights being illuminated when an ingredient is present in a food product, a second of the lights being illuminated when the ingredient is not present in the food product, and a third of the lights being illuminated when the database does not include the scanned food product.

9. The portable device of claim 8, wherein the lights are LEDs.

10. The portable device of claim 7, further comprising a button to activate the barcode scanner.

11. The portable device of claim 7, wherein the display provides a user with a menu display from which the user can select the target food product ingredient via the keypad.

12. The portable device of claim 11, wherein the menu display includes a main menu and at least one sub-menu.

13. The portable device of claim 7, further comprising a read-only-memory chip that holds the database.

14. The portable device of claim 13, wherein the read-only-memory chip is configured to be replaceable by a read-only-memory chip having a revised database of food product ingredients.
